(19) United States
(12) Patent Application Publication
(10) Pub. No.: US 2023/0316805 A1
(43) Pub. Date: Oct. 5, 2023

(54) FACE AUTHENTICATION DEVICE, FACE AUTHENTICATION METHOD, AND RECORDING MEDIUM

(71) Applicant: NEC Corporation, Minato-ku, Tokyo (JP)

(72) Inventor: Kentaro Ozawa, Tokyo (JP)

(73) Assignee: NEC Corporation, Minato-ku, Tokyo (JP)

(21) Appl. No.: 18/023,584

(22) PCT Filed: Sep. 30, 2020
(86) PCT No.: PCT/JP2020/037191

§ 371 Date: Feb. 27, 2023

(51) Int. Cl. G06V 40/16; G06F 21/32

(52) U.S. Cl. CPC G06V 40/171; G06V 40/172; G06F 21/32

(57) ABSTRACT

The face authentication device includes a plurality of collation means which distribute and store a plurality of face feature quantities corresponding to a plurality of faces based on values of shard keys, an acquisition means, a shard key calculation means, and an authentication means. The acquisition means acquires an input face image. The shard key calculation means extracts a plurality of line segments, each defined by feature points of a face, from the input face image and calculates a ratio of the plurality of line segments as the shard key. The authentication means performs authentication of the input face image using the collation means corresponding to the value of the calculated shard key.

### TECHNICAL FIELD

The present disclosure relates to face authentication technology.

### BACKGROUND ART

As an efficient search technique for a large amount of data, there is known a technique which divides the search object by sharding. For example, Patent Document 1 describes a technique, in biometric authentication, which calculates a weighting value indicating the degree of collation for each combination of a collation source and a collation target, and classifies the feature vectors of the collation targets into a plurality of groups using the weighting value.

### PRECEDING TECHNICAL REFERENCES

### Patent Document

Patent Document 1: International Publication WO2018/116918

### SUMMARY

### Problem to be Solved

In face authentication, acceleration of the authentication processing can be expected by sharding when the number of collation objects is enormous. However, in the distributed analysis of unstructured data in the face authentication, it becomes a problem that there is no appropriate key which can be used for the distribution in the previous stage of the collation.

One object of the present disclosure is to provide a face authentication device capable of performing high-speed collation with a large amount of collation objects by distributed processing using an appropriate key.

### Means for Solving the Problem

According to an example aspect of the present disclosure, there is provided a face authentication device comprising:
a plurality of collation means configured to store a plurality of face feature quantities corresponding to a plurality of faces in a manner distributed based on values of shard keys;
an acquisition means configured to acquire an input face image;
a shard key calculation means configured to extract a plurality of line segments, each defined by feature points of a face, from the input face image and calculate a ratio of the plurality of line segments as the shard key; and
an authentication means configured to perform authentication of the input face image, using the collation means corresponding to a calculated value of the shard key.

According to another example aspect of the present disclosure, there is provided a face authentication method comprising:
acquiring an input face image;
extracting a plurality of line segments, each defined by feature points of a face, from the input face image, and calculating a ratio of the plurality of line segments as a shard key; and
performing authentication of the input face image using a collation means corresponding to a calculated value of the shard key among a plurality of collation means, the plurality of collation means storing a plurality of face feature quantities corresponding to a plurality of faces in a manner distributed based on the values of the shard keys.

According to still another example aspect of the present disclosure, there is provided a recording medium recording a program, the program causing a computer to:
acquire an input face image;
extract a plurality of line segments, each defined by feature points of a face, from the input face image, and calculate a ratio of the plurality of line segments as a shard key; and
perform authentication of the input face image using a collation means corresponding to a calculated value of the shard key among a plurality of collation means, the plurality of collation means storing a plurality of face feature quantities corresponding to a plurality of faces in a manner distributed based on the values of the shard keys.

### BRIEF DESCRIPTION OF THE DRAWINGS

FIG. 1 shows an outline of a face authentication system according to a first example embodiment

FIG. 2 is a block diagram showing a hardware configuration of a face authentication server.

FIG. 3 is a block diagram showing a functional configuration of the face authentication server.

FIG. 4 shows a method of calculating a shard key in the first example embodiment.

FIG. 5 shows a method of assigning all feature quantity data to a plurality of face collation nodes.

FIG. 6 is a flowchart of face authentication processing.

FIG. 7 shows correspondence between ranges of pan, roll, and tilt of an input face image and the distance to be used as a shard key.

FIG. 8 shows correspondence between presence or absence of a mask and sunglasses and the distance to be used as a shard key.

FIG. 9 shows a priority order of multiple line segments defined by parts included in a face image.

FIG. 10 is a block diagram showing a functional configuration of a face authentication device according to a sixth example embodiment.

FIG. 11 is a flowchart of face recognition processing according to the sixth example embodiment.

### EXAMPLE EMBODIMENTS

Preferred example embodiments of the present disclosure will be described with reference to the accompanying drawings.

### First Example Embodiment

[Face Authentication System]

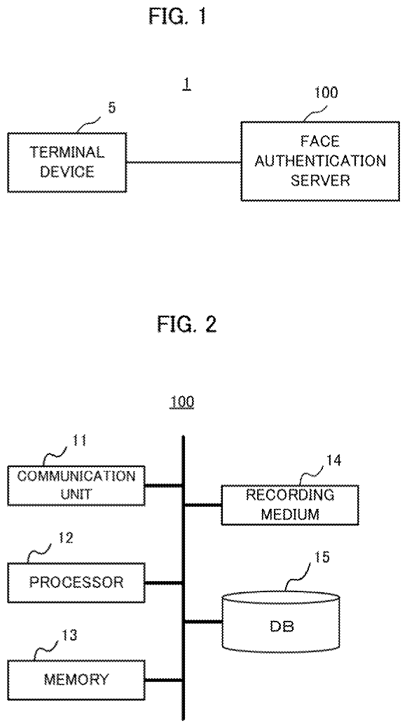

FIG. 1 shows an outline of a face authentication system according to a first example embodiment. The face authentication system 1 includes a terminal device 5 and a face authentication server 100. The terminal device 5 is a client terminal used by a user who performs face authentication, and includes a PC, a tablet, a smartphone, and the like of the user, for example. The user transmits a face image captured by a camera or the like from the terminal device 5 to the face authentication server 100.

The face authentication server 100 stores the face image and/or the feature quantity of the face image for the registered person in advance, and performs face authentication by collating the face image (hereinafter, also referred to as “input face image”), which is an object of the authentication and which is transmitted from the terminal device 5, with the registered face image. Specifically, the face authentication server 100 extracts the feature quantity from the input face image and performs the face authentication by collating it with the plurality of feature quantities registered in the face authentication server 100.

[Hardware Configuration]

FIG. 2 is a block diagram illustrating a hardware configuration of the face authentication server 100. As shown, the face authentication server 100 includes a communication unit 11, a processor 12, a memory 13, a recording medium 14, and a data base (DB) 15.

The communication unit 11 inputs and outputs data to and from an external device. Specifically, the communication unit 11 receives an input face image serving as an object of the authentication from the terminal device 5. Also, the communication unit 11 transmits the authentication result by the face authentication server 100 to the terminal device 5.

The processor 12 is a computer such as a CPU (Central Processing Unit) and controls the entire face authentication server 100 by executing a program prepared in advance. The processor 12 may be a GPU (Graphics Processing Unit) or a FPGA (Field-Programmable Gate Array). Specifically, the processor 12 executes the face authentication processing to be described later.

The memory 13 may include a ROM (Read Only Memory) and a RAM (Random Access Memory). The memory 13 is also used as a working memory during various processing operations by the processor 12.

The recording medium 14 is a non-volatile and non-transitory recording medium such as a disk-like recording medium, a semiconductor memory, or the like, and is configured to be detachable from the face authentication server 100. The recording medium 14 records various programs executed by the processor 12. When the face authentication server 100 executes the face authentication processing, the program recorded in the recording medium 14 is loaded into the memory 13 and executed by the processor 12.

The data base (DB) 15 stores a face image and/or a feature quantity (hereinafter referred to as “registered feature quantity”) extracted from the face image for each of the registered persons. The DB 15 temporarily stores the input face image received through the communication unit 11 and the authentication result of the input face image. In addition, the face authentication server 100 may be provided with a display unit or an input unit used by an administrator to perform a necessary operation or the like.

[Functional Configuration]

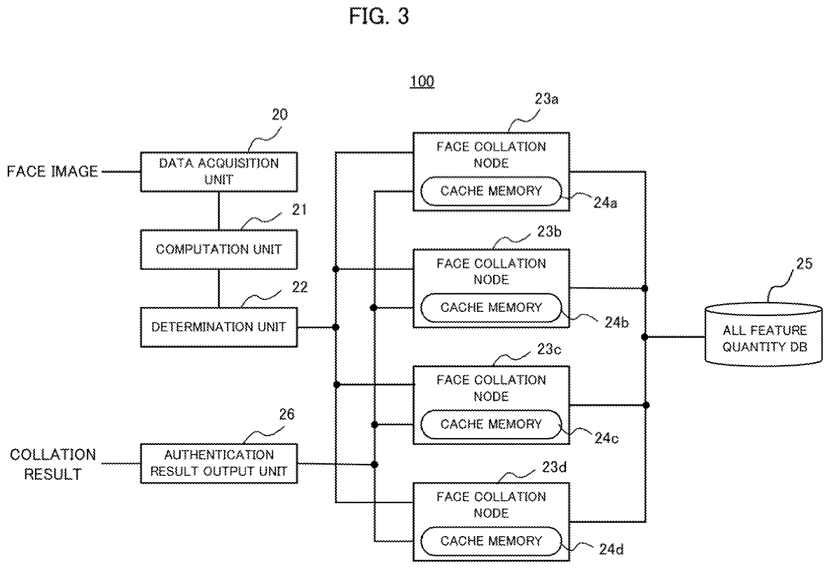

FIG. 3 is a block diagram illustrating a functional configuration of the face authentication server 100. The face authentication server 100 functionally includes a data acquisition unit 20, a computation unit 21, a determination unit 22, face collation nodes 23a to 23d, an all feature quantity DB 25, and an authentication result output unit 26.

The data acquisition unit 20 acquires an input face image serving as an object of the authentication from the terminal device 5 of the user and outputs the input face image to the computation unit 21. The computation unit 21 extracts a feature quantity (hereinafter also referred to as “collation-use feature quantity”) for collating with the registered face image from the input face image and outputs a predetermined feature quantity in the input face image to the determination unit 22 as a shard key.

The computation unit 21 uses, as a shard key, a feature quantity which can be obtained relatively easily from among the information obtained from the face image and which is a stable value. There are many ambiguities in the information obtained from the face image. For example, the accuracy of the age and gender estimated from the face image greatly deteriorates due to cosmetics, wigs, clothing, etc. Therefore, when these are used as the shard keys, erroneous determination may increase. In this view, in the present example embodiment, a T-shaped aspect ratio of both eyes and an upper lip is used as the shard key.

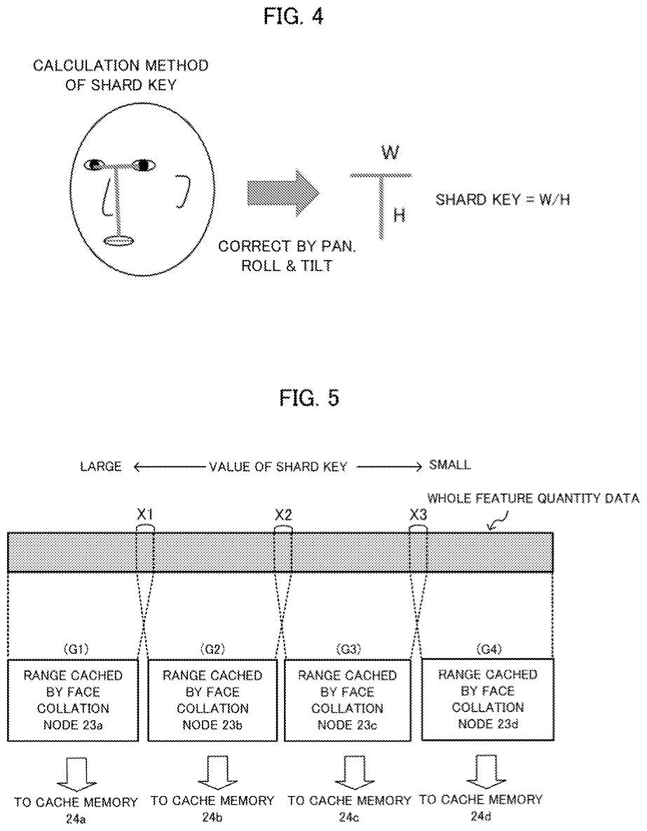

FIG. 4 shows a method of calculating the shard key in the present example embodiment. As shown, the aspect ratio of the T-shape formed by both eyes and the upper lip in the face is used as the shard key. Specifically, the computation unit 21 determines a first line segment connecting the two eyes in the input face image, draws a perpendicular line from the upper lip to the first line segment as a second line segment, and sets the ratio (W/H) of the length of the first line segment (W) and the length of the second line segment (H) as the shard key. It is noted that the computation unit 21 calculates the shard key after performing necessary correction of the input face image in the pan, roll, and tilt directions. The above-mentioned ratio (W/H), i.e., the aspect ratio of the T-shape of both eyes and the upper lip, can be easily measured from the face image, and can be stably measured without depending on the makeup or the like. Therefore, the possibility of misjudgment can be reduced and stable distributed processing of the face authentication can be achieved.

The all feature quantity DB 25 is a DB that stores all the registered feature quantities for the registered persons, and is realized by the DB 15 shown in FIG. 2. All the feature quantity data stored in the all feature quantity DB 25 are distributed to a plurality of nodes by sharding. In the example of FIG. 3, all the feature quantity data are stored in four face collation nodes 23a to 23d in a distributed manner based on the shard key. The face collation nodes 23a to 23d include cache memories 24a to 24d for storing the feature quantity data. In the following description, when referring to one of the four face collation nodes or cache memories, a subscript is added like “the face collation node 23a”, and when not limited to one of them, the subscript is omitted like “the face collation node 23”.

FIG. 5 illustrates the method of assigning all the feature quantity data to the four face collation nodes 23 using the shard key. This processing is executed by the computation unit 21 and the determination unit 22. First, for all the registered face images, the aspect ratio of the T-shape of both eyes and the upper lip is calculated as the shard key. Thus, the values of the shard key corresponding to all the feature quantity data are obtained. Next, as shown in FIG. 5, all the feature quantity data are sorted by the values of the shard key. Then, all the feature quantity data are classified into four groups G1 to G4 based on the shard key values, and are assigned to the face collation nodes 23a to 23d.

Specifically, the group G1 of the feature quantity data having corresponding to the largest shard key values is stored in the cache memory 24a of the face collation node 23a, and the group G2 of the feature quantity data corresponding to the second largest shard key values is stored in the cache memory 24b of the face collation node 23b. Similarly, the group G3 of the feature quantity data corresponding to the third largest shard key values is stored in the cache memory 24c of the face collation node 23c, and the group G4 of the feature quantity data corresponding to the smallest shard key values is stored in the cache memory 24d of the face collation node 23d. Thus, each cache memory 24a to 24d stores the feature quantity data for each of four groups grouped by the values of the shard key. As a result, since it is not necessary to refer to the all feature quantity DB 25 storing all the facial feature quantities each time the collation described later is performed, the processing may be speeded up.

Incidentally, when assigning all the feature quantity data to the four face collation nodes 23a to 23d, it is preferable to consider that there may be some errors in the values of the shard keys calculated from the face images and to make the boundaries of neighboring groups overlap somewhat as shown in FIG. 5. In the example of FIG. 5, the feature quantity data included in the area X1 is stored in both the face collation nodes 23a and 23b, the feature quantity data included in the area X2 is stored in both the face collation nodes 23b and 23c, and the feature quantity data included in the area X3 is stored in both the face collation nodes 23c and 23d. Incidentally, FIG. 3 is merely an example, and the number of the face collation nodes 23 can be determined according to the number of all the feature quantity data.

As described above, the process of assigning all the feature data to the four face collation nodes 23 is executed before starting the face authentication processing for the input face image. When the assignment is completed, the value range of the shard key corresponding to the group of the feature quantity data assigned to each face collation node 23a to 23d is stored in the determination unit 22.

When the determination unit 22 acquires the value of the shard key calculated for the input face image from the computation unit 21, the determination unit 22 selects the face collation node 23 to which the value belongs, and outputs the collation-use feature quantity for the input face image to the selected face collation node 23. For example, if the value of the shard key acquired from the computation unit 21 for a certain input face image is a value corresponding to the face collation node 23b, the determination unit 22 outputs the collation-use feature quantity for the input face image to the face collation node 23b.

The face collation node 23 to which the collation-use feature quantity of the input face image is inputted from the determination unit 22 collates the inputted collation-use feature quantity with the feature quantity data stored in the cache memory 24 and performs the face authentication. For example, when the determination unit 22 outputs the collation-use feature quantity of the input face image to the face collation node 23b based on the shard key value, the face collation node 23b performs the face authentication using the collation-use feature quantity, but basically the other three face collation nodes 23a, 23c and 23d do not perform the face authentication. Incidentally, when the value of the shard key of the input face image belongs to one of the areas X1 to X3 shown in FIG. 5, the two face collation nodes 23 adjoining the one of the areas X1 to X3 perform the face authentication, but the remaining two face collation nodes 23 do not perform the face authentication. Thus, the collation of the feature quantity of the input face image can be speeded up by the distributed processing.

The face collation node 23 that performed the face authentication using the collation-use feature quantity of the input face image outputs the authentication result to the authentication result output unit 26. The authentication result output unit 26 transmits the authentication result to the terminal device 5 of the user. Thus, the user can know the authentication result.

In the above-described configuration, the data acquisition unit 20 is an example of the acquisition means, the computation unit 21 is an example of the shard key calculation means and the feature quantity extraction means, and the determination unit 22 and the face collation node 23 are an example of the authentication means. Further, the computation unit 21 and the determination unit 22 is an example of the storage control means, and the all feature quantity DB 25 is an example of the storage means.

[Face Authentication Processing]

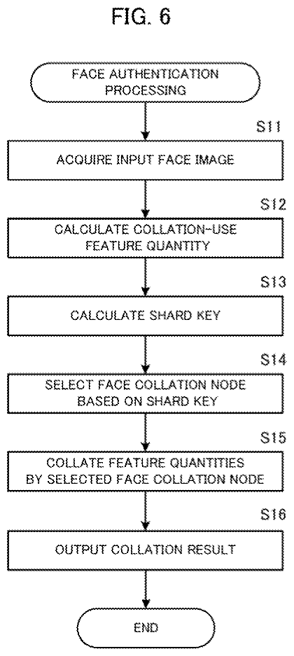

Next, a description will be given of face authentication processing executed by the face authentication server 100. FIG. 6 is a flowchart of the face authentication processing. This processing is realized by the processor 12 shown in FIG. 2, which executes a program prepared in advance and operates as the elements shown in FIG. 3. As a precondition of the processing, it is assumed that all the feature quantity data are distributed and cached in the face collation nodes 23a to 23d based on the value of the shard key as described above.

First, the data acquisition unit 20 acquires an input face image from the terminal device 5 (step S11). Next, the computation unit 21 calculates the collation-use feature quantity from the input face image (step S12) and further calculates the shard key from the input face image (step S13).

Next, the determination unit 22 selects the face collation node 23 corresponding to the calculated shard key from among the plurality of face collation nodes 23 and outputs the collation-use feature quantity to the selected face collation node 23 (step S14). The selected face collation node 23 collates the collation-use feature quantity of the input face image calculated in step S12 with the feature quantities cached in the selected face collation node 23 (step S15). Then, the authentication result output unit 26 outputs the authentication result to the terminal device 5 (step S16). Then, the face authentication processing ends.

As described above, in the first example embodiment, since the T-shape aspect ratio of both eyes and the upper lip is used as the shard key, the shard key can be easily and stably calculated from the face image, and the distributed processing of the face authentication can be stably performed.

### Second Example Embodiment

Next, a description will be given a second example embodiment. In the first example embodiment, the aspect ratio of the T-shape of both eyes and the upper lip, specifically, the ratio (W/H) of the length (W) of the first line segment connecting both eyes in the face image and the length (H) of the second line segment, which is a perpendicular line drawn from the upper lip to the first line segment, is used as the shard key. In contrast, in the second example embodiment, the length (distance) of the following line segments that can be stably acquired from the face image is used.
(1) Length of the line segment connecting the hole of either the left or right ear and the center of the pupil
(2) Length of the line connecting both eyes
(3) Length of the perpendicular line drawn from the upper lip to the line segment connecting both eyes
(4) Length of the perpendicular line drawn from the nose tip to the line segment connecting both eyes
(5) Length of the perpendicular line drawn from the jaw tip to the line segment connecting both eyes
(6) Length of the line segment connecting the nose tip and jaw tip
(7) Length of the line connecting the lower lip and jaw tip
(8) Length of the line segment connecting the hole of either the left or right ear and the nose tip
(9) Length of the perpendicular line drawn from the eye to the line segment connecting the hole of either the left or right ear and the nose

Specifically, in the second example embodiment, the ratio of the above two or more lengths is used as a shard key. Thus, the shard key may be generated by using the ratio of the lengths that can be obtained relatively stably from the face image. Incidentally, except for this point, the second example embodiment is the same as the first example embodiment.

### Third Example Embodiment

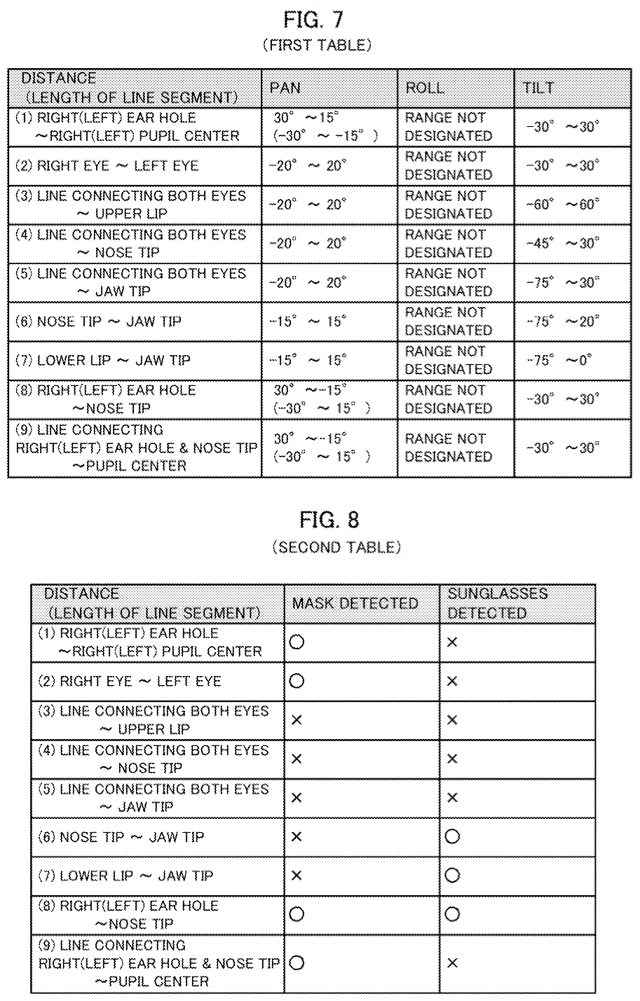

Next, a description will be given of a third example embodiment. In the third example embodiment, the parts of the face that are used to calculate the shard key is determined based on the amount of the pan, roll, and tilt of the input face image. Specifically, the computation unit 21 computes the pan, roll, and tilt from the input face image, and determines the distance (the length of the line segment) used as the shard key with reference to the first table shown in FIG. 7. FIG. 7 shows the correspondence between the range of the pan, roll, and tilt of the input face image and the distance (length of line segment) to be used in that range. In the first table shown in FIG. 7, the pan is expressed on the assumption that the front direction of the user's face is 0 degrees, the left direction is set to a negative value and the right direction is set to a positive value. For the tilt, the front direction of the user's face is 0 degrees, the upward direction is positive, and the downward direction is negative.

For example, in the case where the computation unit 21 calculated the pan and tilt from the input face image, if the pan belongs to the range “−20° to 20°” and the tilt belongs to the range “−30° to 30°”, the distance (2), i.e., the line segment connecting both eyes can be used. If the pan belongs to the range “−20° to 20°” and the tilt belongs to the range “−60° to 60°” at the same time, the distance (3), i.e., the perpendicular line drawn from the upper lip to the line segment connecting both eyes can be used. Therefore, the computation unit 21 can use the ratio of the lengths of those two line segments as the shard key. In the case of generating the shard key using the distances selected as described above, the number of the face collation nodes 23 may be increased as necessary.

According to the third example embodiment, since the shard key is calculated using the face parts captured in the input face image on the basis of the result of calculating the pan and tilt from the input face image, the distributed processing using the shard key can be stabilized. Incidentally, except for this point, the third example embodiment is the same as the first example embodiment.

### Fourth Example Embodiment

Next, a description will be given of a fourth example embodiment. In the fourth example embodiment, the parts of the face used to calculate the shard key is determined based on whether or not the input face image includes a mask or sunglasses. Specifically, the computation unit 21 detects the mask and the sunglasses by analyzing the input face image, and determines the distances (the length of the line segment) used to calculate the shard key with reference to the second table shown in FIG. 8. FIG. 8 shows the correspondence between the presence or absence of a mask and sunglasses and the distance (length of line segment) to be used as the shard key.

For example, when the computation unit 21 detects the mask from the input face image but does not detect sunglasses, the ratio of two or more of the distances (1), (2), and (9) can be used as the shard key. In the case of generating the shard key using the distance selected as described above, the number of the face collation nodes 23 may be increased as necessary.

According to the fourth example embodiment, since the shard key is calculated using the parts of the face that are captured in the input face image based on the result of detecting the mask and the sunglasses from the input face image, the distributed processing by the shard key can be stabilized. Incidentally, except for this point, the fourth example embodiment is the same as the first example embodiment.

### Fifth Example Embodiment

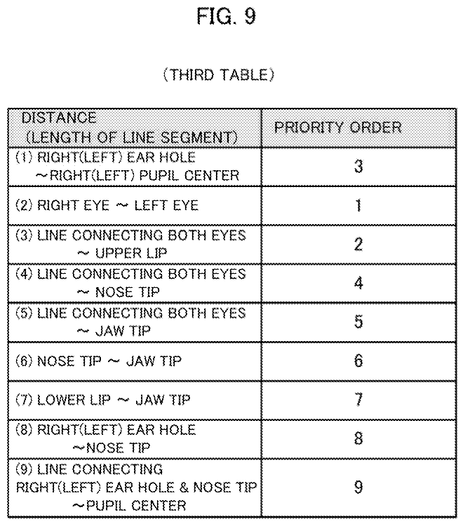

Next, a description will be given of a fifth example embodiment. In the fifth example embodiment, multiple line segments defined by the parts included in the face image are used for the calculation of the shard key according to a predetermined priority. FIG. 9 is an example of a third table prescribing a priority order for the multiple line segments defined by the parts in the face image. The computation unit 21 detects the parts of the face in the input face image and calculates the shard key using the lengths of the usable line segments according to the priority order shown in FIG. 9.

Now, it is assumed that the ratio of the lengths of the two line segments is used as the shard key. For example, when all the parts of the face are captured in the input face image, the computation unit 21 calculates the ratio of the distance (2) and the distance (3) as the shard key according to the priority order shown in FIG. 9. On the other hand, when the vicinity of the eye is not captured in the input face image, the computation unit 21 calculates the ratio of the distance (6) and the distance (7) in which the eye position is not used as the shard key according to the priority order shown in FIG. 9. In the case of generating the shard key using the distances selected as described above, the number of the face collation nodes 23 may be increased as necessary.

According to the fifth example embodiment, since the shard key is calculated by selecting the distances according to the priority order based on the plurality of parts of the faces appearing in the input face image, it is possible to stabilize the distributed processing by the shard key. Incidentally, except for this point, the fifth example embodiment is the same as the first example embodiment.

### Sixth Example Embodiment

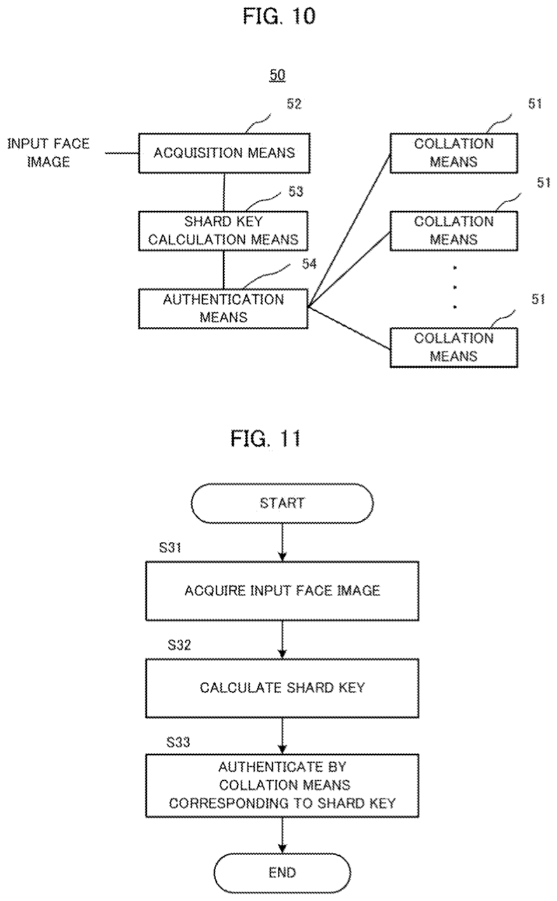

Next, a description will be given of a sixth example embodiment. FIG. 10 is a block diagram showing a functional configuration of a face authentication device 50 according to the sixth example embodiment. The face authentication device 50 includes a plurality of collation means 51, an acquisition means 52, a shard key calculation means 53, and an authentication means 54. The plurality of collation means 51 stores a plurality of face feature quantities corresponding to a plurality of faces in a manner distributed based on values of shard keys. The acquisition means 52 acquires an input face image. The shard key calculation means 53 extracts a plurality of line segments each defined by feature points of a face from the input face image and calculates a ratio of the plurality of line segments as a shard key. The authentication means 54 performs authentication of the input face image using the collation means corresponding to the value of the calculated shard key.

FIG. 11 is a flowchart of face recognition processing according to the sixth example embodiment. First, the acquisition means 52 acquires an input face image (step S31). Next, the shard key calculation means 53 extracts a plurality of line segments each defined by feature points of a face from the input face image and calculates a ratio of the plurality of line segments as a shard key (step S32). Then, the authentication means 54 performs authentication of the input face image using the collation means corresponding to the calculated value of the shard key, from among the plurality of collation means storing a plurality of face feature quantities corresponding to a plurality of faces in a manner distributed based on the values of the shard keys (step S33).

According to the sixth example embodiment, since the plurality of line segments each defined by the feature points of the face is extracted from the input face image and the ratio of the plurality of line segments is used as the shard key, the shard key can be stably generated from the face image, and the distributed processing of the face authentication can be stably performed.

### Seventh Example Embodiment

When the number of the registered person is increased after the registered feature quantities stored in the all feature quantity DB 25 is distributed and stored in the plurality of face collation nodes 23, the numbers of the registered feature quantities stored in the face collation nodes 23 may be biased. In such a case, the registered feature quantities stored in the all feature quantity DB 25 may be redistributed to the plurality of face collation nodes 23. Namely, the updating processing may be executed.

In addition, the number of the face collation nodes 23 may be increased according to the increase of the registered persons. For example, it is supposed that the registered feature quantities are distributed to and stored in the four face collation nodes 23 at a certain point of time as illustrated in FIG. 3. Thereafter, when the number of the registered person increases and the total number of the registered feature quantities in the all feature quantity DB 25 exceeds a predetermined reference number, the face collation node 23 may be increased by one, and all the registered feature quantities at that time may be redistributed to the five face collation nodes 23.

### Eighth Example Embodiment

While the technique of this disclosure is applied to the face authentication in the above-described first to seventh example embodiments, the technique of this disclosure may be applied to biometric authentication related to a hand, for example, fingerprint authentication, hand vein authentication, palm print authentication, and the like. Incidentally, for the vein recognition and palmprint recognition of the hand, it is a presupposition that a photographic image of the whole hand can be acquired. In this case, for example, by using the ratio of the distances from the base of each of the five fingers to the fingertip, or the ratio of the length between the first joint and the second joint of a particular finger and the entire length of the finger, as the shard key, the same processing as in the above example embodiments can be executed.

A part or all of the example embodiments described above may also be described as the following supplementary notes, but not limited thereto.

(Supplementary note 1)

A face authentication device comprising:
a plurality of collation means configured to store a plurality of face feature quantities corresponding to a plurality of faces in a manner distributed based on values of shard keys;
an acquisition means configured to acquire an input face image;
a shard key calculation means configured to extract a plurality of line segments, each defined by feature points of a face, from the input face image and calculate a ratio of the plurality of line segments as the shard key; and an authentication means configured to perform authentication of the input face image, using the collation means corresponding to a calculated value of the shard key.

(Supplementary Note 2)

The face authentication device according to Supplementary note 1, wherein the shard key is a ratio of a length of a line segment connecting both eyes to a length of a perpendicular line drawn from an upper lip to the line segment in a face image.

(Supplementary Note 3)

The face authentication device according to Supplementary note 1, wherein the line segment is one of: a line segment connecting either one of left and right ear holes with a center of a pupil; a line segment connecting both eyes; a perpendicular line drawn from an upper lip to the line segment connecting both eyes; a perpendicular line drawn from a nose tip to the line segment connecting both eyes; a perpendicular line drawn from a jaw tip to the line segment connecting both eyes; a line segment connecting the nose tip with the jaw tip; a line segment connecting a lower lip with the jaw tip; a line segment connecting either one of the left and right ear holes with the nose tip; and a perpendicular line drawn from an eye to the line segment connecting either one of the left and right ear holes with the nose tip.

(Supplementary note 4)

The face authentication device according to any one of Supplementary notes 1 to 3, further comprising a first table defining the lengths of the line segments to be used to calculate the shard key in correspondence with amounts of a pan, a roll and a tilt of the face image, wherein the shard key calculation means calculates the amounts of the pan, the roll, and the tilt of the input face image, and calculates the shard key by determining the line segments to be used with reference to the first table.

(Supplementary note 5)

The face authentication device according to any one of Supplementary notes 1 to 3, further comprising a second table defining the lengths of the line segments to be used as the shard key in a case where the face image includes at least one of a mask and sunglasses, wherein the shard key calculation means detects whether or not the input face image includes a mask and sunglasses, and calculates the shard key by determining the line segments to be used with reference to the second table.

(Supplementary note 6)

The face authentication device according to any one of Supplementary notes 1 to 3, further comprising a third table indicating a priority order of a plurality of line segments defined by the feature points of the face, wherein the shard key calculation means calculates the shard key by selecting a plurality of line segments having high priority from the plurality of line segments defined by the feature points included in the input face image.

(Supplementary note 7)

The face authentication device according to any one of Supplementary notes 1 to 6, further comprising a feature quantity extraction means configured to extract a feature quantity from the input face image, wherein the authentication means collates the feature quantity extracted from the input face image with the feature quantity stored in the collation means.

(Supplementary note 8)

The face authentication device according to any one of Supplementary notes 1 to 7, further comprising a storage control means configured to distribute and store the feature quantities of the plurality of faces stored in the storage means to the plurality of collation means based on the shard key.

(Supplementary note 9)

A face authentication method comprising:
acquiring an input face image;
extracting a plurality of line segments, each defined by feature points of a face, from the input face image, and calculating a ratio of the plurality of line segments as a shard key; and
performing authentication of the input face image using a collation means corresponding to a calculated value of the shard key among a plurality of collation means, the plurality of collation means storing a plurality of face feature quantities corresponding to a plurality of faces in a manner distributed based on the values of the shard keys.

(Supplementary note 10)

A recording medium recording a program, the program causing a computer to:
acquire an input face image;
extract a plurality of line segments, each defined by feature points of a face, from the input face image, and calculate a ratio of the plurality of line segments as a shard key; and
perform authentication of the input face image using a collation means corresponding to a calculated value of the shard key among a plurality of collation means, the plurality of collation means storing a plurality of face feature quantities corresponding to a plurality of faces in a manner distributed based on the values of the shard keys.

While the present disclosure has been described with reference to the example embodiments and examples, the present disclosure is not limited to the above example embodiments and examples. Various changes which can be understood by those skilled in the art within the scope of the present disclosure can be made in the configuration and details of the present disclosure.

### DESCRIPTION OF SYMBOLS

5 Terminal device
12 Processor
20 Data acquisition unit
21 Computation unit
22 Determination unit
23 Face collation node
24 Cache memory
25 All feature quantity DB
26 Authentication result output unit
100 Face authentication server

What is claimed is:

1. A face authentication device comprising:
a plurality of collation units configured to store a plurality of face feature quantities corresponding to a plurality of faces in a manner distributed based on values of shard keys;
a memory configured to store instructions; and
one or more processors configured to execute the instructions to:
acquire an input face image;
extract a plurality of line segments, each defined by feature points of a face, from the input face image and calculate a ratio of the plurality of line segments as the shard key; and
perform authentication of the input face image, using the collation unit corresponding to a calculated value of the shard key.

2. The face authentication device according to claim 1, wherein the shard key is a ratio of a length of a line segment connecting both eyes to a length of a perpendicular line drawn from an upper lip to the line segment in a face image.

3. The face authentication device according to claim 1, wherein the line segment is one of: a line segment connecting either one of left and right ear holes with a center of a pupil; a line segment connecting both eyes; a perpendicular line drawn from an upper lip to the line segment connecting both eyes; a perpendicular line drawn from a nose tip to the line segment connecting both eyes; a perpendicular line drawn from a jaw tip to the line segment connecting both eyes; a line segment connecting the nose tip with the jaw tip; a line segment connecting a lower lip with the jaw tip; a line segment connecting either one of the left and right ear holes with the nose tip; and a perpendicular line drawn from an eye to the line segment connecting either one of the left and right ear holes with the nose tip.

4. The face authentication device according to claim 1, further comprising a first table defining the lengths of the line segments to be used to calculate the shard key in correspondence with amounts of a pan, a roll and a tilt of the face image,
wherein the one or more processors calculate the amounts of the pan, the roll, and the tilt of the input face image, and calculates the shard key by determining the line segments to be used with reference to the first table.

5. The face authentication device according to claim 1, further comprising a second table defining the lengths of the line segments to be used as the shard key in a case where the face image includes at least one of a mask and sunglasses,
wherein the one or more processors detect whether or not the input face image includes a mask and sunglasses, and calculate the shard key by determining the line segments to be used with reference to the second table.

6. The face authentication device according to claim 1, further comprising a third table indicating a priority order of a plurality of line segments defined by the feature points of the face,
wherein the one or more processors calculate the shard key by selecting a plurality of line segments having high priority from the plurality of line segments defined by the feature points included in the input face image.

7. The face authentication device according to claim 1,
wherein the one or more processors are further configured to extract a feature quantity from the input face image image, and
wherein the one or more processors collate the feature quantity extracted from the input face image with the feature quantity stored in the collation unit.

8. The face authentication device according to claim 1, wherein the one or more processors are further configured to distribute and store the feature quantities of the plurality of faces stored in a storage to the plurality of collation units based on the shard key.

9. A face authentication method comprising:
acquiring an input face image;
extracting a plurality of line segments, each defined by feature points of a face, from the input face image, and calculating a ratio of the plurality of line segments as a shard key; and
performing authentication of the input face image using a collation unit corresponding to a calculated value of the shard key among a plurality of collation units, the plurality of collation units storing a plurality of face feature quantities corresponding to a plurality of faces in a manner distributed based on the values of the shard keys.

10. A non-transitory computer-readable recording medium recording a program, the program causing a computer to:
acquire an input face image;
extract a plurality of line segments, each defined by feature points of a face, from the input face image, and calculate a ratio of the plurality of line segments as a shard key; and
perform authentication of the input face image using a collation unit corresponding to a calculated value of the shard key among a plurality of collation units, the plurality of collation units storing a plurality of face feature quantities corresponding to a plurality of faces in a manner distributed based on the values of the shard keys.
